(19) United States
(12) Patent Application Publication
(10) Pub. No.: US 2004/0247057 A1
(43) Pub. Date: Dec. 9, 2004

(54) Automatic gain control apparatus with short settling time

(76) Inventors: Gil-Yong Park, Suwon-si (KR); Hyeon-Cheol Ki, Seongnam-si (KR); Shin-Hee Won, Seoul (KR); Tae-Sung Park, Yongin-si (KR); Yun-Je Oh, Yongin-si (KR)

Correspondence Address: CHA & REITER, LLC, 210 ROUTE 4 EAST STE 103, PARAMUS, NJ, 07652, US

(21) Appl. No.: 10/776,718

(22) Filed: Feb. 11, 2004

(30) Foreign Application Priority Data
Jun. 4, 2003 (KR) 2003-35967

(51) Int. Cl. H04L 27/08

(52) U.S. Cl. 375/345

(57) ABSTRACT

An automatic gain control (AGC) apparatus with a short settling time in a burst mode optical receiver is disclosed. The AGC apparatus includes a variable gain amplifier for variably amplifying an input signal according to an AGC adjustment control signal; a clipper coupled to an output terminal of the variable gain amplifier for comparing an output signal of the variable gain amplifier with a preset signal V_{cut} and for outputting a signal corresponding to the difference between these two signals if the output signal of the variable gain amplifier is higher than or equal to the preset signal V_{cut} in amplitude; an exponential amplifier for exponentially amplifying an output signal of the clipper; and a peak holder for detecting a peak value from an output signal of the exponential amplifier and for generating the AGC adjustment control signal for controlling a gain of the variable gain amplifier.

### CLAIM OF PRIORITY

This application claims priority under 35 U.S.C. § 119 to an application entitled “Automatic Gain Control Apparatus with Short Settling Time,” filed in the Korean Intellectual Property Office on Jun. 4, 2003 and assigned Serial No. 2003-35967, the contents of which are incorporated herein by reference.

### BACKGROUND OF THE INVENTION

1. Field of the Invention

The present invention generally relates to an optical reception apparatus used in an optical subscriber network, and in particular, to a burst mode optical receiver.

2. Description of the Related Art

The next generation communication demands to transmit a larger amount of information to subscribers at a higher speed. Accordingly, researches have been conducted on a subscriber network that is capable of accommodating the increase in the amount of data traffic and audio/video service.

Recently, a passive optical network (PON) which is an optical subscriber network using passive elements became popular as a subscriber network. In particular, an Ethernet PON (hereinafter referred to as “EPON”) using an Ethernet frame is becoming very popular.

In a general PON, a plurality of ONTs/ONUs (Optical Network Terminals/Optical Network Units) is connected to an optical line terminal (OLT) for exchanging data.

In operation, for a downsteam transmission, the same signal is transmitted from one OLT to a plurality of ONTs/ONUs on a broadcasting basis. For an upstream transmission, all upstream signals from a plurality of ONTs/ONUs are transmitted simultaneously to the OLT, so that a collision between the upstream signals is unavoidable. In order to resolve this problem, a time division multiplexing access (TDMA) scheme has been adapted for the transmission of the upstream signals according to the time slots assigned to the ONTs/ONUs.

Since the ONTs/ONUs are located at different distances from the OLT, the upstream signals transmitting from the ONTs/ONUs to the OLT have different optical power. Therefore, the OLT must have a wide input dynamic range in order to receive the upstream signals having different optical power. In order to secure a wide input dynamic range, an optical receiver performs automatic gain control (AGC) for minimizing the signal distortion by enabling a low-power input signal to have a high gain and a high-power input signal to have a low gain. More particularly, in order to widen the input dynamic range of the burst mode data that is received by the packet as in the EPON, a faster AGC operation is required.

FIG. 1 illustrates an example of an AGC apparatus according to the prior art. As illustrated in FIG. 1, the AGC apparatus includes a variable gain amplifier (VGA) 11 for variably amplifying an input signal according to an AGC adjustment control signal, a signal amplitude detector 12 for detecting the amplitude of a signal received from the variable gain amplifier 11, a differential amplifier 13 for amplifying the difference between an output of the signal amplitude detector 12 and a reference voltage V_{ref} and for outputting the amplified difference as an AGC adjustment control signal to the variable gain amplifier 11, and a low pass filter (LPF) 14 for removing a high frequency component from the AGC adjustment control signal, which is an output signal of the differential amplifier 13.

More specifically, an electric signal generated through photoelectric conversion in an undepicted external photodiode is amplified by the variable gain amplifier 11 according to an AGC adjustment control signal, and the output of the variable gain amplifier 11 is provided to the signal amplitude detector 12. The signal amplitude detector 12 detects amplitude of an output signal of the variable gain amplifier 11, and then an output of the signal amplitude detector 12 is provided to the differential amplifier 13. The differential amplifier 13 amplifies the difference between the output of the signal amplitude detector 12 and a preset reference voltage V_{ref}, such that an output signal of the differential amplifier 13 is used as an AGC adjustment control signal for the variable gain amplifier 11. The variable gain amplifier 11 controls its amplification gain according to the level of the AGC adjustment control signal. The AGC adjustment control signal, which is an output signal of the differential amplifier 13, contains a high frequency component. As such, the low pass filter 14 is used to remove the high frequency component.

In a burst mode optical communication system, a settling time is generally a very important factor in the AGC operation for a burst signal. In the conventional AGC apparatus shown in FIG. 1, an output of the differential amplifier 13, i.e., an AGC adjustment control signal generated according to amplitude of an input signal, must pass through the low pass filter 14. However, the low pass filter 14 has a large time constant, causing a considerable increase in settling time. In addition, a longer operation delay time by the signal amplitude detector 12 causes an additional increase in the AGC settling time. Therefore, the conventional AGC apparatus has a longer settling time that is undesirable.

Furthermore, the amplitude of an AGC adjustment control signal generated in the AGC apparatus is not monotonous and fluctuates with the passage of time, causing a difficulty in performing an automatic threshold control (ATC) in order to determine the different reference value in each packet of the burst mode data.

### SUMMARY OF THE INVENTION

The present invention is directed to an automatic gain control apparatus with a short settling time, wherein an AGC adjustment control signal has a monotonous characteristic.

In one embodiment, an automatic gain control (AGC) apparatus with a short settling time in a burst mode optical receiver is provided and includes a variable gain amplifier for variably amplifying an input signal according to an AGC adjustment control signal; a clipper coupled to an output terminal of the variable gain amplifier for comparing an output signal of the variable gain amplifier with a preset signal V_{cut} and for outputting a signal corresponding to a difference between the two signals if the output signal of the variable gain amplifier is higher than or equal to the preset signal V_{cut} in amplitude; an exponential amplifier for exponentially amplifying an output signal of the clipper; and a peak holder for detecting a peak value from an output signal of the exponential amplifier and generating the AGC adjustment control signal for controlling the gain of the variable gain amplifier.

### BRIEF DESCRIPTION OF THE DRAWINGS

The above features and advantages of the present invention will become more apparent from the following detailed description when taken in conjunction with the accompanying drawings in which:

FIG. 1 illustrates an example of an AGC apparatus according to the prior art;

FIG. 2 illustrates an example of an AGC apparatus according to an embodiment of the present invention;

FIG. 3 illustrates a detailed structure of the peak holder in the AGC apparatus according to an embodiment of the present invention;

FIG. 4 illustrates a detailed circuit diagram of the peak holder in the AGC apparatus according to an embodiment of the present invention;

FIG. 5 illustrates a detailed circuit diagram of the VCVR in the AGC apparatus according to an embodiment of the present invention; and

FIG. 6 illustrates a detailed circuit diagram of the clipper and the exponential amplifier in the AGC apparatus according to an embodiment of the present invention.

### DETAILED DESCRIPTION OF THE PREFERRED EMBODIMENT

A preferred embodiment of the present invention will now be described in detail with reference to the annexed drawings. For the purposes of clarity and simplicity, a detailed description of well known functions and configurations is omitted herein.

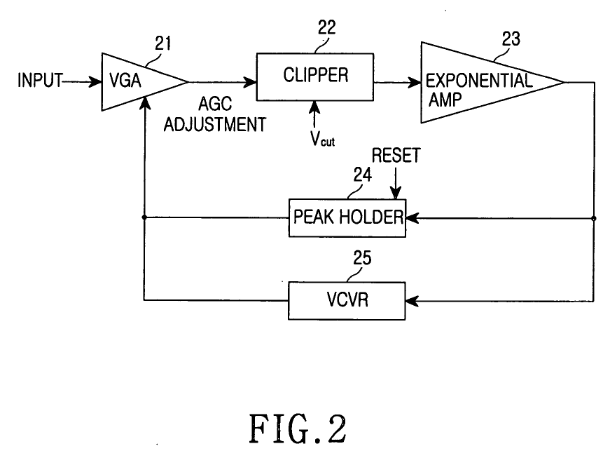

FIG. 2 illustrates an example of an AGC apparatus according to an embodiment of the present invention. As shown, an AGC apparatus according to the present invention includes a variable gain amplifier (VGA) 21 for variably amplifying an input signal according to an AGC adjustment control signal, a clipper 22 for comparing an output signal of the variable gain amplifier 21 with a preset signal V_{cut} and for outputting a signal corresponding to the difference between these two signals if the output signal of the variable gain amplifier 21 is higher than or equal to the preset signal V_{cut} in amplitude, an exponential amplifier 23 for exponentially amplifying an output signal of the clipper 22, a peak holder 24 for detecting a peak value from an output signal of the exponential amplifier 23, holding the detected peak value, and generating an AGC adjustment control signal for the variable gain amplifier 21, and a voltage controlled variable resistor (VCVR) 25 connected in parallel to the peak holder 24 for preventing overcurrent from flowing in the peak holder 24 when the output signal of the exponential amplifier 23 is larger than or equal to the preset threshold value.

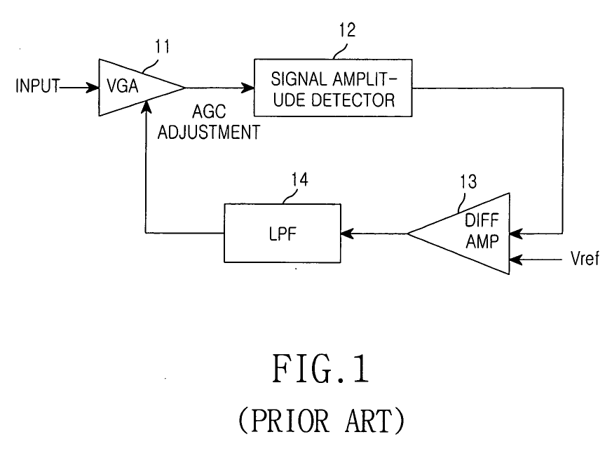

A detailed description will now be made of an operation of the AGC apparatus according to the present invention. The variable gain amplifier 21 variably amplifies an input signal according to an AGC adjustment control signal and provides its output signal to the clipper 22. The clipper 22 clips a signal lower than a specific level and outputs only a signal higher than the specific level. Here, the specific level is set to a preset voltage V_{cut}. Since only the signal higher than the specific level is used as a source for generating an AGC adjustment control signal, the AGC operation is performed using the signal higher than the preset voltage V_{cut}. In essence, the clipper 22 serves as the signal amplitude detector 12, as in the conventional AGC apparatus of FIG. 1, by determining whether the AGC operation is performed which in turn provides a drastic reduction in complexity and operation delay time of the circuit.

A clipped signal output from the clipper 22 is applied to the peak holder 24 via the exponential amplifier 23. The peak holder 24 holds the peak value of an output signal of the exponential amplifier 23 and applies its output signal to a gain control terminal of the variable gain amplifier 21 to adjust an amplification gain. Herein, the peak holder 24 has a function of removing a high frequency component from the AGC adjustment control signal, as in the low pass filter 14 of the conventional AGC apparatus of FIG. 1. In this case, the peak holder 24 can operate with a very small time constant as compared with the low pass filter 14, thus contributing to a remarkable reduction in AGC settling time.

The exponential amplifier 23 exponentially amplifies the clipped signal and provides its output to the peak holder 24. This is done to reduce a time delay for which the peak holder 24 holds the peak value. More specifically, a time constant of the peak holder 24 becomes a main factor in determining an AGC settling time, and an increase in level of the AGC adjustment control signal increases the settling time. Thus, if a time constant of the peak holder 24 is fixed and the amplitude of an input signal is increased with respect to the fixed time constant, then the time delay can be reduced. That is, by exponentially amplifying the clipped signal and then applying the exponentially-amplified signal to the peak holder 24, a deviation of the settling time based on the level of the AGC adjustment control signal is decreased, thus minimizing the maximum settling time or the actual settling time.

Meanwhile, if the time constant of the peak holder 24 is small and an output signal of the variable gain amplifier 21 is highly increased in amplitude, the peak holder 24 may be overcharged by a peak current in the process of generating an AGC adjustment control signal in the AGC apparatus according to the present invention. In order to prevent the overcharge, the VCVR 25 is connected in parallel to the peak holder 24 as illustrated in FIG. 2.

The VCVR 25, connected in parallel to the peak holder 24 provides an instantaneous current leakage path when an output level of the exponential amplifier 23 is increased to a high level, thereby preventing a capacitor for holding a voltage within the peak holder 24 from being overcharged.

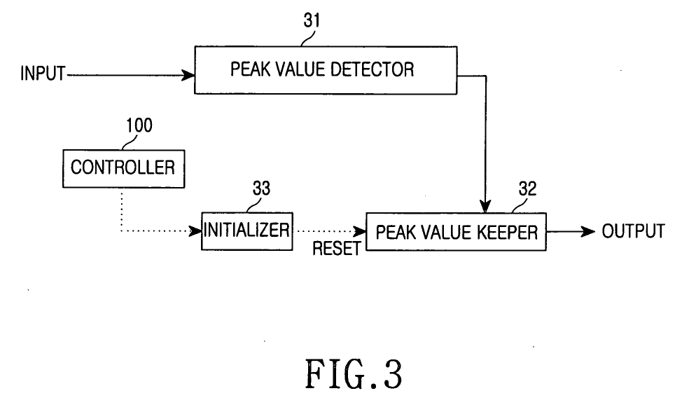

FIG. 3 illustrates a detailed structure of the peak holder in the AGC apparatus according to an embodiment of the present invention. As shown, the peak holder 24 in the AGC apparatus according to the present invention includes a peak value detector 31 for detecting the peak value of a signal received from the exponential amplifier 23, and a peak value keeper 32 for keeping the peak value detected by the peak value detector 31, outputting the kept peak value, and initializing the kept peak value according to an initialization signal from the outside.

Further, the AGC apparatus according to the present invention includes at the outside thereof an initializer 33 for generating a reset signal for initializing a peak value in the peak value keeper 32 according to a new input signal to the AGC apparatus, and a controller 100 for controlling the initializer 33 to generate the reset signal by detecting the new input signal to the AGC apparatus. Particularly, the initializer 33 initializes the peak value keeper 32 by receiving, from the controller 100, information indicating that there is no more data input to the AGC apparatus and then delivers the information to the peak value keeper 32, so that the peak value keeper 32 has a new peak value when the next data is received.

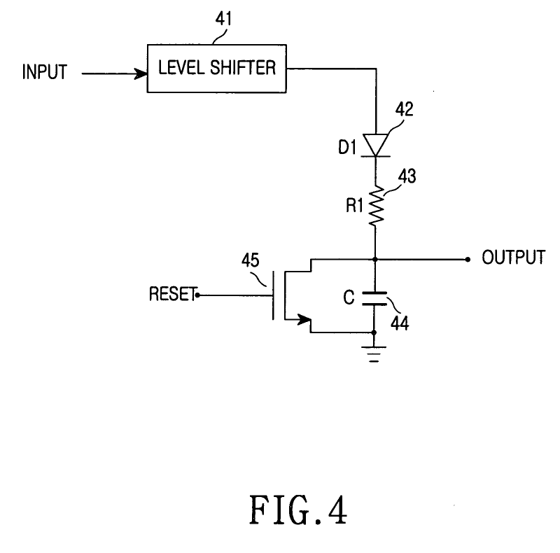

FIG. 4 illustrates a detailed circuit diagram of the peak holder 24 in the AGC apparatus according to an embodiment of the present invention. As shown, the peak value detector 31 includes a level shifter 41 for receiving a signal output from the exponential amplifier 23 and converting a DC (Direct Current) level of the received signal so that a DC level of the received signal is matched to a DC level of the corresponding element (i.e., the peak holder 24), a diode (D1) 42, and a resistor (R1) 43. The peak value keeper 32 is comprised of a capacitor (C) 44 and a MOS FET (Metal-Oxide Semiconductor Field Effect Transistor) 45 connected in parallel to the capacitor 44. The capacitor 44 charges a peak value therein and holds the charged peak value, and the MOS FET 45 is switched by the reset signal from the initializer 33 to discharge the capacitor 44, thereby performing initialization.

Now, a detailed description of the initialization operation will now be made herein below with reference to FIGS. 3 and 4.

Upon receiving, from the controller 100, information indicating that there is no more data input to the AGC apparatus, the initializer 33 generates a reset signal for initializing the peak value keeper 32 and applies the generated reset signal to the gate of the MOS FET 45 in the peak value keeper 32. If a voltage difference occurs between a gate and a source of the MOS FET 45, a drain-source channel becomes conductive. As a result, if the reset signal is applied to the gate of the MOS FET 45, the drain-source channel of the MOS FET 45 connected in parallel to the capacitor 44 is short-circuited, thus discharging a voltage charged in the capacitor 44.

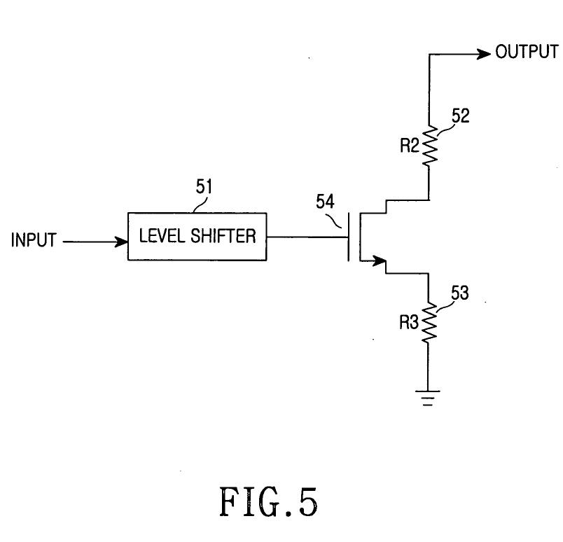

FIG. 5 illustrates a detailed circuit diagram of the VCVR 25 in the AGC apparatus of FIG. 2 according to an embodiment of the present invention. As shown, the VCVR 25 in the AGC apparatus according to the present invention is connected in parallel to the peak holder 24 and includes a level shifter 51 for receiving an output signal of the exponential amplifier 23 and for converting a DC level of the received signal, so that a DC level of the received signal is matched to a DC level of the corresponding element (i.e., the VCVR 25); a MOS FET 54 for receiving the level-shifted signal at its gate and performing a switching operation to provide an instantaneous current leakage path for preventing a capacitor for holding a voltage within the peak holder 24 from being overcharged; a drain resistor (R2) 52 of the MOS FET 54; and a source resistor (R3) 53 of the MOS FET 54.

In operation, when an output signal of the exponential amplifier 23 becomes higher in amplitude than a specific level previously set for an operation of the MOS FET 54, the MOS FET 54 is turned ON and its output is grounded via the resistors R2 and R3. As a result, a considerable part of a current generated by a voltage applied to the capacitor 44 in the peak holder 24 connected in parallel to the VCVR 25 is bypassed through the VCVR 25 having a large resistance due to the serial connection of its resistors R2 and R3, thereby providing an instantaneous current leakage path for the capacitor 44 in the peak holder 24. In this manner, the VCVR 25 prevents the capacitor for holding a voltage within the peak holder 24 from being overcharged.

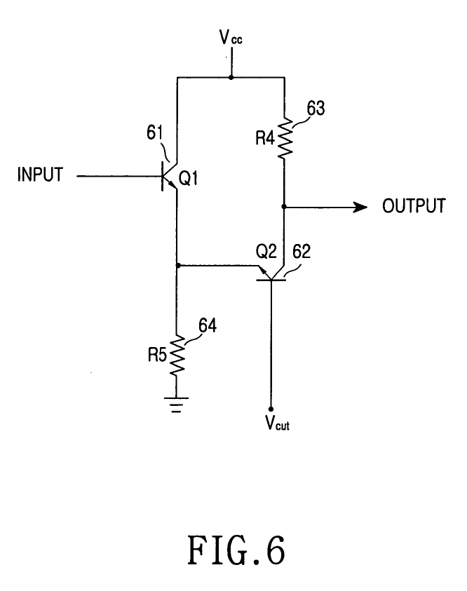

FIG. 6 illustrates a detailed circuit diagram of the clipper 22 and the exponential amplifier 23 in the AGC apparatus of FIG. 2 according to an embodiment of the present invention. As shown, the clipper 22 and the exponential amplifier 23 may be realized in the same circuit. This embodiment provides a circuit in which the clipper 22 and the exponential amplifier 23 are realized using two BJTs (Bipolar Junction Transistors) 61 and 62, and two resistors 63 and 64.

An NPN-type BJT (Q1) 61 receives an output signal of the variable gain amplifier 21 at a base thereof. A collector of the BJT Q1 is connected in common to a supply voltage Vcc and one end of the resistor R4 (63). An emitter of the BJT Q1 is connected in common to an emitter of an NPN-type BJT (Q2) 62 and one end of the resistor R5 (64). One end of the resistor R4 is connected to the collector of the BJT Q1 and the Vcc, and another end of the resistor R4 is connected to a collector of the BJT Q2. Here, one point between another end of the resistor R4 and the collector of the BJT Q2 is branched to output a final signal of the clipper 22 and the exponential amplifier 23.

The BJT Q2 receives through a base thereof a specific voltage value corresponding to a preset clipping value. The collector of the BJT Q2 is connected to another end of the resistor R4, and the emitter of the BJT Q2 is connected in common to the emitter of the BJT Q1 and one end of the resistor R5. One end of the resistor R5 is connected in common to the emitter of the BJT Q1 and the emitter of the BJT Q2, and another end of the resistor R5 is grounded.

As stated above, the emitters of the BJTs Q1 and Q2 are connected in common, and the base of the BJT Q2 is connected to a specific voltage value V_{cut} from the outside. Therefore, if a signal lower than the specific voltage value V_{cut} is applied to the base of the BJT Q1, the BJTs Q1 and Q2 are turned OFF, so that no signal is output. However, if a signal higher than the specific voltage value V_{cut} is applied to the base of the BJT Q1, the BJTs Q1 and Q2 are turned ON, so that the BJT Q2 outputs a signal at its collector. This circuit has an exponential amplification characteristic based on a diode characteristic of the BJTs.

As explained above, the present invention provides an AGC apparatus having a short AGC settling time. By combining the AGC apparatus with an ATC apparatus and a limiting amplifier in the following stage, it is possible to provide an efficient burst mode optical receiver having a fast burst mode response characteristic. In addition, the present invention prevents an excessive inflow of the initial current using the VCVR, thereby solving a disadvantage of prior art that an initial signal is not monotonous when the AGC adjustment control signal is generated.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An automatic gain control (AGC) apparatus having a short settling time in a burst mode optical receiver, comprising:
a variable gain amplifier for variably amplifying an input signal according to an AGC adjustment control signal;
a clipper coupled to an output terminal of the variable gain amplifier for comparing an output signal of the variable gain amplifier with a preset signal V_{cut} and for outputting a signal difference when the output signal of the variable gain amplifier is higher than or equal to the preset signal V_{cut} in amplitude;
an exponential amplifier for exponentially amplifying an output signal of the clipper; and
a peak holder for detecting a peak value from an output signal of the exponential amplifier and for generating the AGC adjustment control signal for controlling a gain of the variable gain amplifier.

2. The AGC apparatus of claim 1, further comprising a voltage controlled variable resistor (VCVR) coupled in parallel to the peak holder for creating a current leakage path and for preventing overcurrent from flowing in the peak holder when the output signal of the exponential amplifier is larger than or equal to a preset threshold.

3. The AGC apparatus of claim 1, wherein the peak holder comprises:
a peak value detector for converting a DC (Direct Current) level of an output signal of the exponential amplifier so that the DC level of the output signal of the exponential amplifier is matched to a DC level of the peak holder; and
a peak value keeper for keeping a peak value of the output signal of the exponential amplifier and for generating the AGC adjustment control signal to control a gain of the variable gain amplifier from the kept peak value.

4. The AGC apparatus of claim 3, wherein the peak value keeper initializes the kept peak value according to an initialization signal.

5. The AGC apparatus of claim 4, wherein, upon receiving a signal that there is no more data input to the AGC apparatus, the initialization signal is delivered to initialize the peak value keeper in order to detect a new peak value when the next data is received.

6. The AGC apparatus of claim 1, wherein the clipper and the exponential amplifier comprise:
a first transistor having a base receiving an output signal of the variable gain amplifier, a collector connected in common to a supply voltage Vcc and one end of a first resistor, and an emitter connected in common to an emitter of a second transistor and one end of a second resistor;
a second transistor having a base receiving a specific voltage value corresponding to a preset clipping value, a collector connected to another end of the first resistor, and an emitter connected in common to the emitter of the first transistor and one end of the second resistor;
the first resistor having one end connected in common to the collector of the first transistor and the supply voltage Vcc, and another end connected to the collector of the second transistor; and
the second resistor having one end connected in common to the emitter of the first transistor and the emitter of the second transistor, and another end grounded.
